(19) United States
(12) Patent Application Publication
(10) Pub. No.: US 2008/0277901 A1
(43) Pub. Date: Nov. 13, 2008

(54) Size-Reducible Folding Tricycle for Children

(75) Inventors: Pietro Catelli, Como (IT); Michele Catelli, Como (IT)

Correspondence Address: OBLON, SPIVAK, MCCLELLAND MAIER & NEUSTADT, P.C., 1940 DUKE STREET, ALEXANDRIA, VA, 22314, US

(73) Assignee: ARTSANA S.p.A., Grandate (IT)

(21) Appl. No.: 12/088,147

(22) PCT Filed: Sep. 29, 2005
(86) PCT No.: PCT/EP2005/010527

§ 371 Date: Mar. 26, 2008

(51) Int. Cl. B62K 15/00

(52) U.S. Cl. 280/287

(57) ABSTRACT

A folding tricycle (1) for children comprises a frame (2) having a central part (3) carrying at its front a head tube (5) and connected at its rear to first ends (11) of rear arms (12) carrying a corresponding rotatable wheel (14), the first end (11) of said arms (12) being hinged to said central part (3) such as to be able to assume at least two working positions, in a first position said arms (12) extending from said central part (3) and in a second position they ling along the side of said part (3). The central part (3) of the frame (2) comprises a portion (17) connecting it to the arms (12) and presenting free surfaces (16) lying in planes inclined to a central plane (W) of the frame (2) and converging to the front said central part (3) of this latter, said first end (11) of said arms (12) being shaped to provide a form fit with said free surfaces (16).

The present invention relates to a tricycle in accordance with the introduction to the main claim.

A tricycle is known to comprise a frame having a central part supporting at its front a head tube through which there rotatably passes a steering shaft connected to a front wheel and to a handlebar, said central part supporting a seat and being connected at its rear to side arms carrying rotatable wheels and projecting radially from said central part.

Tricycles are known in which a first end of said arms is hinged to said central part so that said arms can assume two working positions, in a first of which they project radially from said part and in a second of which they lie to the said thereof to reduce the tricycle dimensions. Such a tricycle is described for example in U.S. Pat. No. 4,457,529.

An object of the present invention is to provide a tricycle of the stated type which is of very small dimensions when its side arms lie in their second working position.

Another object is to provide a tricycle of the stated type, the dimensions of which can also be reduced on only one of its sides.

A further object is to provide a tricycle of the stated type which is reliable in use and of which the dimensions can be easily reduced.

These and other objects which will be apparent to the expert of the art are attained by a tricycle in accordance with the accompanying claims.

The present invention will be more apparent from the accompanying drawing, which is provided by way of non-limiting example and in which:

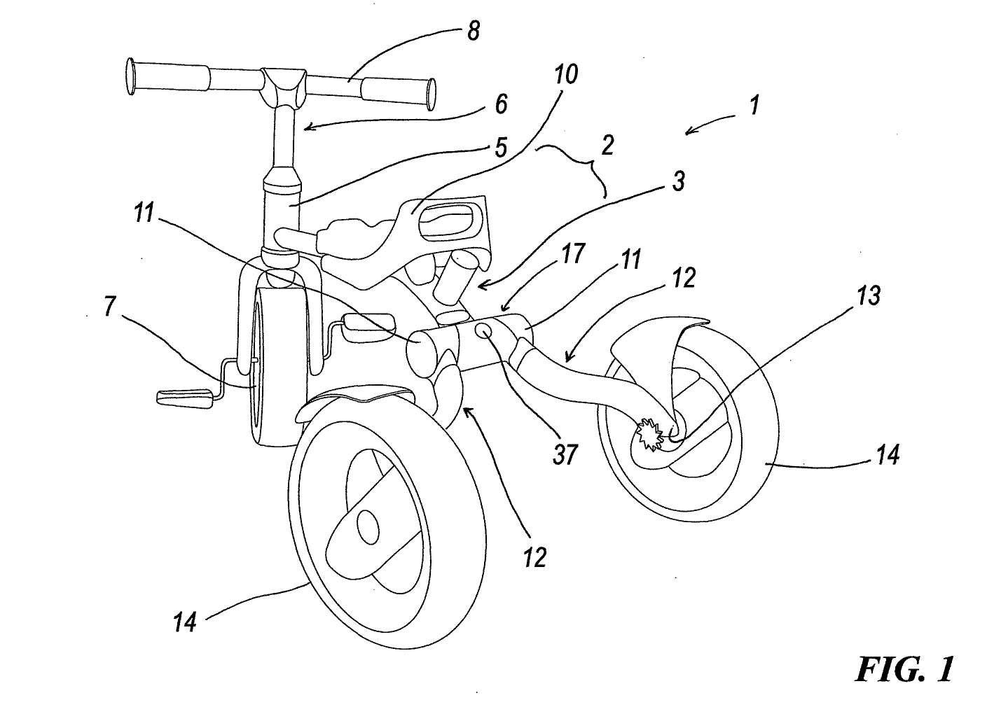

FIG. 1 is a perspective view of a tricycle of the invention in a first working position, seen from the rear;

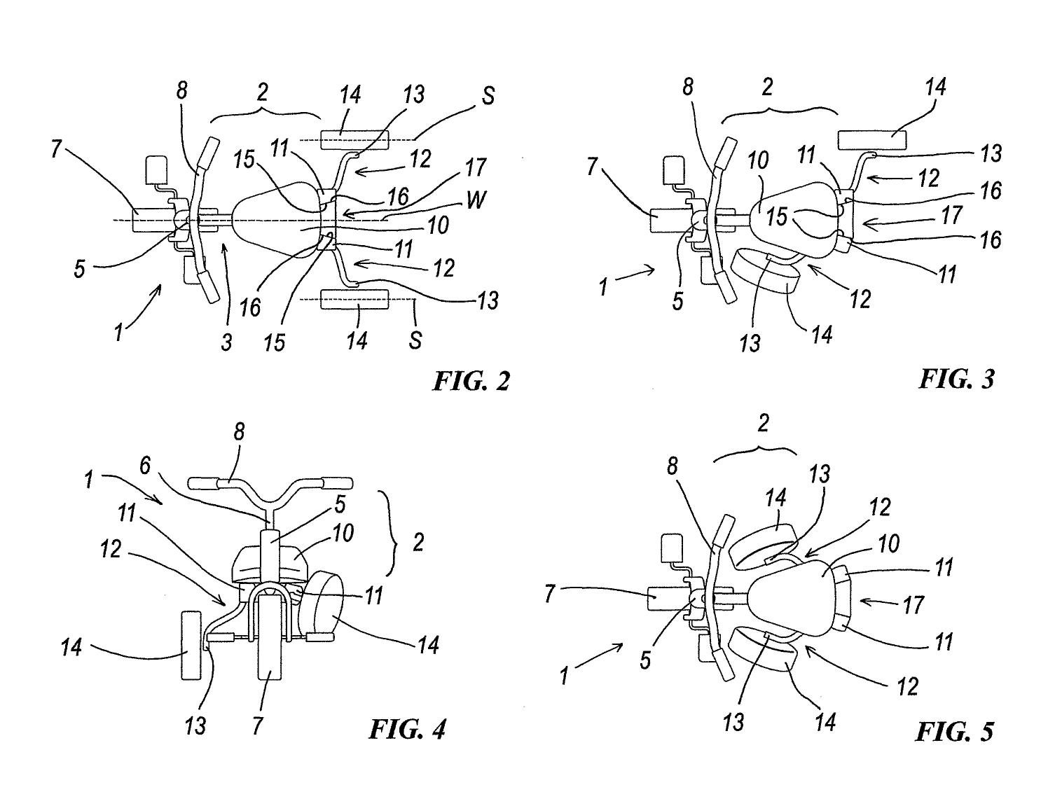

FIG. 2 is a view of the tricycle of FIG. 1, seen from above;

FIG. 3 is a view of the tricycle of FIG. 1 in a different working position, seen from above;

FIG. 4 is a front view of the tricycle of FIG. 3;

FIG. 5 is a view of the tricycle of FIG. 1 in a further working position, seen from above;

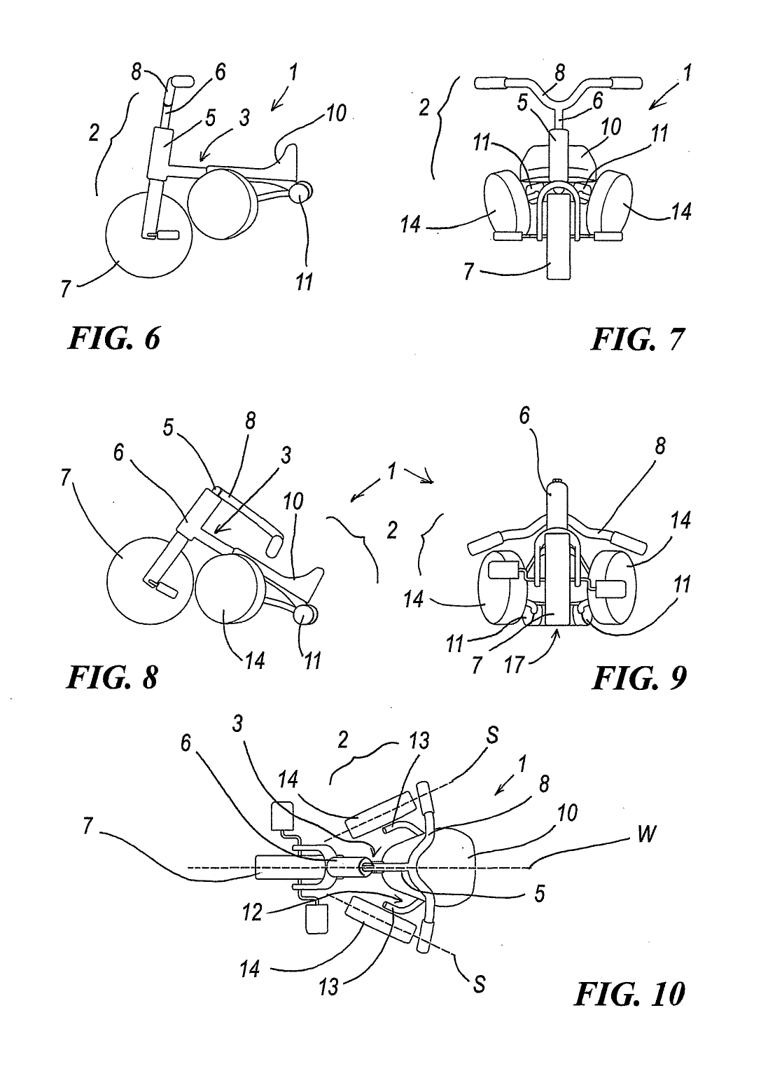

FIG. 6 is a side view of the tricycle of FIG. 5;

FIG. 7 is a front view of the tricycle of FIG. 5;

FIG. 8 is a side view of the tricycle of FIG. 1, shown in a further working position;

FIG. 9 is a front view of the tricycle of FIG. 8;

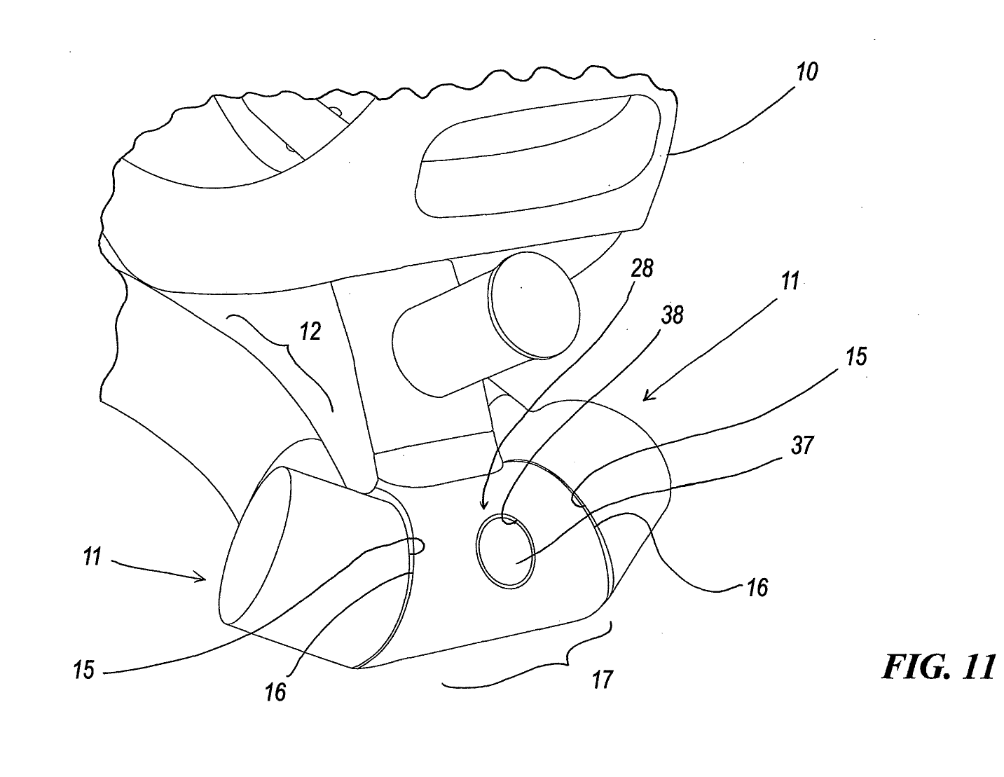

FIG. 10 is a view of the tricycle of FIG. 8, seen from above;

FIG. 11 is a perspective view of a part of the tricycle of FIG. 8, seen from the rear;

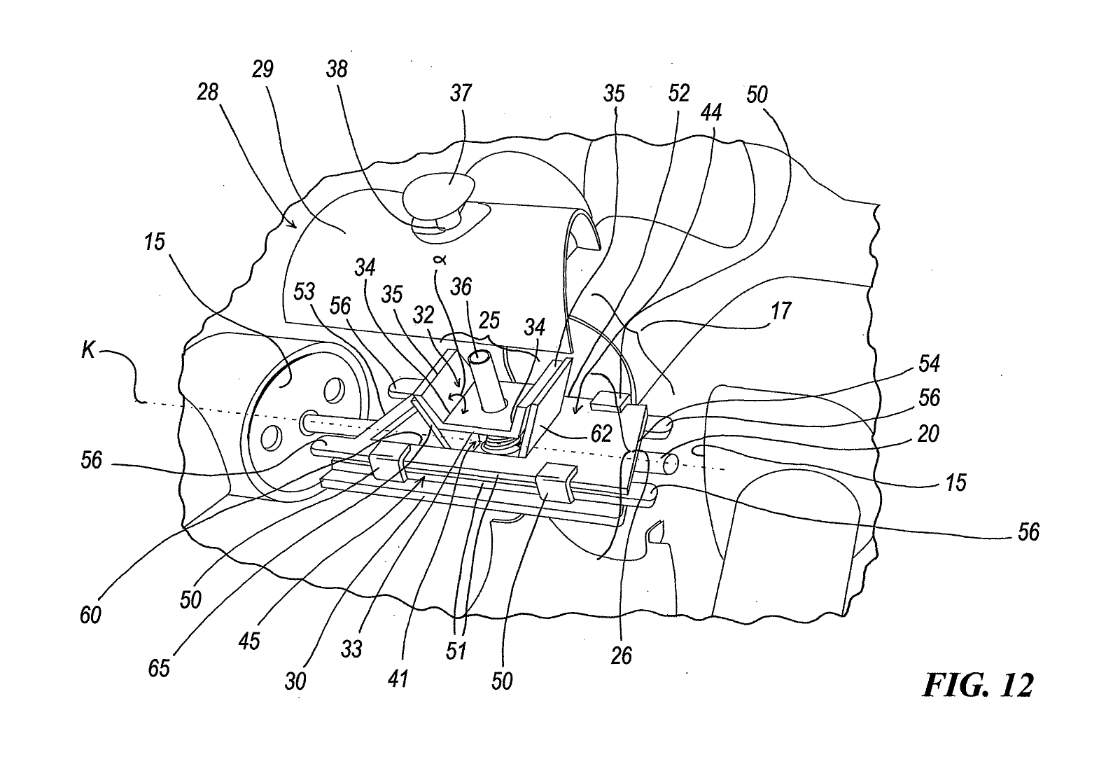

FIG. 12 is an exploded perspective view of the tricycle part of FIG. 11, seen from the rear;

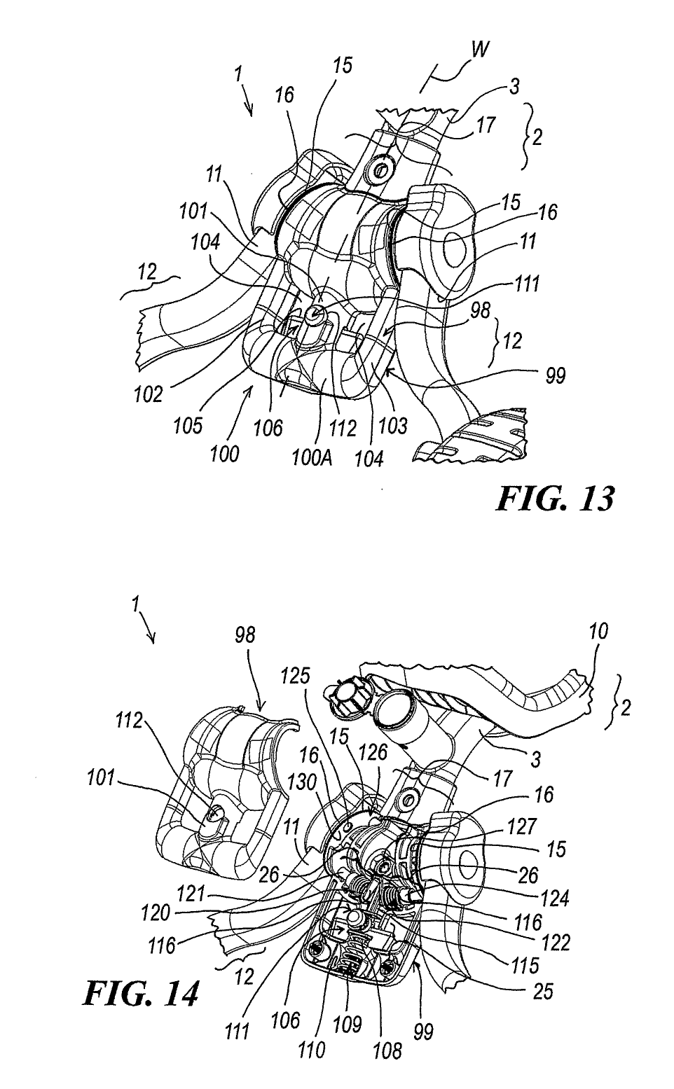

FIG. 13 is a view of a detail of a variant of the invention seen from the rear, in an extended working position;

FIG. 14 is a view similar to FIG. 13, but with certain parts shown exploded;

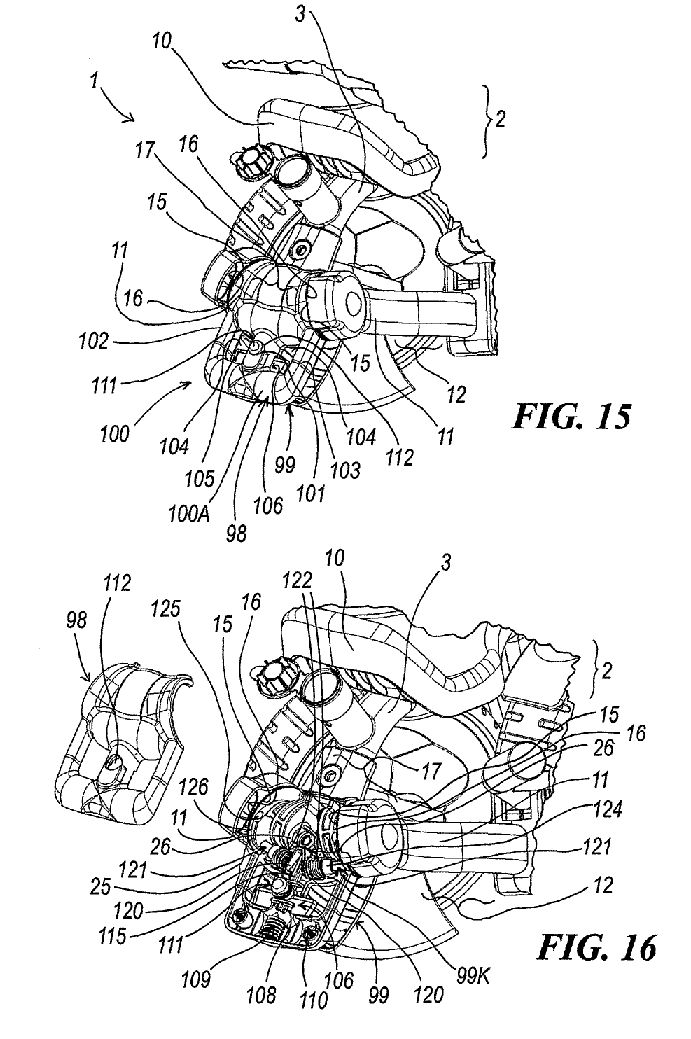

FIG. 15 is a view similar to FIG. 13, but with the tricycle folded;

FIG. 16 is a view similar to FIG. 14, but showing the tricycle in its folded position.

With reference to FIGS. 1-12, a tricycle of the invention is indicated overall by 1 and comprises a frame 2 having a central part 3 carrying at its front a head tube 5 through which a steering shaft 6 is rotatably inserted and connected lowerly (by means of a fork) to a wheel 7 (the tricycle front wheel) and upperly to a handlebar 8.

The central part 3 carries a seat 10 and is connected at its rear to first ends 11 of arms 12 which at their second end 13 carry a rotatable wheel 14. The first end 11 of each arm 12 is hinged to said central part 3 by a coupling formed by the cooperation between an end surface 15 and a corresponding free surface 16 of a connecting portion 17 of said central part 3, said connecting portion comprising a pin 20 about which the ends 11 of the arms 12 can rotate to enable these latter to assume at least one first working position (FIGS. 1 and 2) in which each arm 11 projects radially from the central part 3 of the frame 2 or at least one second working position (FIGS. 5-7) in which said arm lies along the side of said central part 3.

More specifically, the free surfaces 16 of the connecting portion 17 lie in planes inclined to a central plane (defined by the axis W of FIGS. 2 and 10) of the frame 2 of the tricycle 1 and converging to the front of said central part 3 of the tricycle. Likewise, the end surfaces 15 of said arms 12 are shaped to provide a form fit with the corresponding surfaces and consequently lie in a plane inclined to the longitudinal axis K of the respective first ends 11 (see FIG. 12).

By virtue of these shapes of the surfaces 15 and 16, when each arm 12 is brought into its second working position it lies such that the central plane S through the respective wheel 14 cuts the axis W of the frame 2 so that the planes S of the two wheels 14 (see FIGS. 2 and 10) converge towards the front of the tricycle. This allows a considerable reduction in the transverse dimensions of the tricycle when in its second working position (see FIG. 5).

To enable each arm 11 to be moved independently of each other, the connecting portion 17 comprises release means 15 for said movement which are arranged to cooperate with corresponding counter-means 26 operationally cooperating with the first ends 11 of said arms 12.

More specifically, in a first embodiment of the invention shown in particular in FIGS. 11 and 12, the portion 17 comprises a casing 28 defined by two parts 29 and 30 defining an inner compartment housing the means 25 and counter-means 26. The means 25 comprise a slide 32 having a flat part 33, from the opposing edges 34 of which there extend lugs 35 inclined to the part 33 by an obtuse angle α. A pin 36 projects upwards from the flat part 33 to cooperate with a pushbutton 37 disposed axially movable in a seat 38 in the part 29 of the casing 28 of the portion 17. Below said flat part 33 a compression spring 41 is present resting on the part 30 of said casing 28 and suitably fixed (in known manner and therefore not shown), at its opposite ends, to said parts 30 and 33. The counter-means 26 comprise superposed flat elements 44 and 45 guidedly slidable relative to each other on the part 30 of the casing 28 within guides defined by L-shaped brackets 50 rising from said part 30. Each flat element (of substantially rectangular shape) comprises opposing sides 51 and 52 cooperating with said brackets and other sides 53 and 54 perpendicular to the sides 51; the side 53 comprises projections 56 arranged to cooperate with seats 57 provided in the end surface 15 of the ends 11 of the adjacent arm 12. Each flat element 44 and 45 comprises an aperture 60, from one side 61 of which there rises a lug 62 inclined to the element 44 by an angle equal to the aforesaid angle a and consequently parallel to the adjacent lug 35 of the slide 32 against which the lug 35 rests.

From the element 45 there rises a lug 65 inclined to said lug and parallel to the adjacent lug 35 of the slide 32, against which it rests. The lugs 62 and 65 define a seat with movable walls for the slide 32, this seat tapering towards the part 30 of the casing 28. Consequently, by acting on the pushbutton 37 and pushing it towards the part 29 of the casing 28, the slide 32 moves towards said part 30 so that the lugs 35 of this latter cooperate with the lugs 62 and 65 of the flat elements 44 and 45. This cooperation results in mutual withdrawal of said lugs 62 and 65 (in a direction perpendicular to that of the movement of the slide 32) and hence in movement of the flat elements 44 and 45 relative to the part 30 of the casing 28. This movement results in the emergence of the projections 56 from the relative seats 57 and hence the ability to rotate the arms 12 about the pin 20, common to both the arms (or in two parts individually cooperating with these latter).

On releasing the pushbutton 37, the spring 41 withdraws it from the part 29 of the casing 28, while at the same time usual elastic elements (not shown) cooperating with the elements 44 and 45, and which oppose their aforesaid movement, bring these latter into their starting position in which their projections 56 again penetrate into the seats 57 (rotated through 180° compared with FIG. 12) to lock the arms 12.

Alternatively, the slide 32 can be connected to the lugs 62 and 65 in known manner (for example by movable pins in inclined guides) such that the movement of the slide relative to the part 30 of the casing 28 results in a withdrawal movement of these lugs, but also to an approach of these latter.

Finally, the steering shaft 5 can also be foldable so that the dimensions of the tricycle can be further reduced, as shown in FIGS. 8, 9, 10.

FIGS. 13-16, in which parts corresponding to those of the already described figures are indicated by the same reference numerals, show a variant of the aforesaid means 25 and 26. In the figures under examination, the connecting portion 17 presents a projecting part 100 (defined by a part 99 rigid with the part 3 and provided with a protection cover 98) presenting a central part 101 and two side portions 102, 103 defining through apertures 104, these portions being connected to one end 100A of the part 100.

The apertures 104 accommodate one end 105 of a lever 106 movable relative to the part 100 and to its end 100A, it having a pin 108 internal to this latter and on which there is mounted one end of a spring 109 resting on a shoulder 110 within the part 100, and rigid with a pushbutton 111 movable, against the spring, relative to a hole 112 provided within the central part 101 of the part 100. On projecting from this hole (FIG. 13), the pushbutton 111 prevents movement of the lever 106 relative to said end 100A, whereas if pressed into the hole 112 (FIG. 15) it allows this movement against the spring 109.

The lever 106 is rigid with a rod 115 movable within the portion 101 of the part 100 and carrying at its free end opposing inclined lugs 116 converging towards the rod 115. On said lugs 116 (defining a wedge) there rest the flanged ends 120 of sleeves 124 rigid with pins 121 and slidable within the part 99. On each sleeve 124 there is mounted a spring 122 cooperating at its first end with the flange 120 of the sleeve 124, and with its other end thrusting against a wall 99K of the part 99.

Each pin 121 cooperates with a hole 125 provided in a disc 126, for example of metal, rigid with the end surface 15 of a corresponding arm 12 and substantially defining this surface. The arm 12 rotates about an axis as in the case of FIGS. 11 and 12, defined for example by a screw 127 which fixes the arm 12 to the connecting portion 17.

The aforedescribed cooperation between the pin 121 and the corresponding hole 125 takes place at least in the case in which the corresponding arm 12 is extended from the central part 3 (FIG. 14). When the arm 12 is folded towards this latter, the pin 121 is able to rest on the flat surface 130 of the disc 126; alternatively and preferably, another hole 125 can be provided in said disc to receive the pin when the arm 12 is folded (as visible in FIG. 14).

To pass from the projecting position in which at least one arm 12 projects form the part 3 (first working position) to that in which said arm is folded against the side of said part (second working position), the pushbutton 111 is pressed and the lever 106 moved towards the end 100A of the part 100. This movement displaces the lugs 116 from the flanged ends 120 of the pins 121 which, under the thrust action of the respective springs, approach each other by moving transversely towards the rod 115. This results in the emergence of each pin from the corresponding hole 125 and the ability to rotate the arms 12 relative to the portion 17 and to the part 3. After these have been displaced from the corresponding hole 125, the lever 106 can be released as the pins 121 rest on the surface 130 of the corresponding disc 126. The arms 12 can hence be folded towards the part 3. This movement stops when each pin 121 cooperates with the corresponding hole 125 provided in the disc 126 in a position such as to cooperate with the pin only when the arm 12 has been folded into its end position.

It should be noted that the part 100 of the portion 17 can be advantageously used as a handle for transporting the tricycle when folded.

Various preferred embodiments of the invention have been described. Others are however possible (for example relative to the means allowing the arms 12 to be moved and the positioning in the various working positions), these falling within the invention as described by the accompanying claims.

It should be noted that as the arms 12 are mutually independent, the tricycle can also be compacted on only one side, as shown in FIG. 3, which can be advantageous for example for transporting the tricycle.

1. A folding tricycle (1) for children, comprising a frame (2) having a central part (3) carrying at its front a head tube (5) through which there passes a steering shaft (6) connected to a front wheel (7) and to a handlebar (8), said central part (3) being connected at its rear to first ends (11) of rear arms (12) carrying a corresponding rotatable wheel (14) at their second end (13), the first end (11) of said arms (12) being hinged to said central part (3) such as to be able to assume at least two working positions, in a first position said arms (12) extending from said central part (3) and in a second position they lying along the side of said part (3), characterised in that the central part (3) of the frame (2) comprises a portion (17) connecting it to said first end (11) of said arms (12), said connecting portion (17) presenting free surfaces (16) lying in planes inclined to a central plane (W) of the frame (2) and converging to the front of said central part (3) of this latter, said first end of said arms (12) being shaped to provide a form fit with said free surfaces (16) and cooperating with these such that when in said second working position said arms (12) converge towards said central part (3).

2. A tricycle as claimed in claim 1, characterised in that the ends (11) of the rear arms (12) are hinged to said connecting portion (17) about a hinge pin (20) rigid with said portion.

3. A tricycle as claimed in claim 2, characterised in that the connecting portion comprises a casing (28) with which means (25) and corresponding counter-means (26) are associated enabling each arm to move about the corresponding hinge pin (20).

4. A tricycle as claimed in claim 3, characterised in that the means (25) enabling said arms (12) to move are a member (32) slidable within the connecting portion (17) and cooperating with elements (44, 45) movable in a direction perpendicular to that of the slidable member (32) in order to block the movement of the rear wheels (12) in any working position.

5. A tricycle as claimed in claim 4, characterised in that the slidable member (32) moves against a spring (41) and comprises, cooperating with the spring, a flat wall (33) from the sides of which there project inclined lugs (35), each of which cooperates with a corresponding inclined lug (62, 65) of each movable element (44, 45).

6. A tricycle as claimed in claim 3, characterised in that the slidable member (32) cooperates with a pushbutton (37) positioned on the casing 28) of the connecting portion (17).

7. A tricycle as claimed in claim 4, characterised in that the casing (28) of the connecting portion (17) comprises two superposed parts (29, 30) containing said means (25) and counter-means (26), a first part (29) lying above the second (30), on this latter there moving the movable elements (44, 45) guided by guide means (50) associated with said second part (30).

8. A tricycle as claimed in claim 7, characterised in that the guide means are L-shaped brackets associated with the second part (30) of the casing (28) of the connecting portion.

9. A tricycle as claimed in claim 1, characterised in that when the arms (12) are in their second working position, the central planes (S) through the rotatable wheels (14) associated therewith converge to the front of the tricycle central part (3).

10. A tricycle as claimed in claim 3, characterised in that the means (25) enabling the arms (12) to move are a member (106) which is movable within the connecting portion (17) and is rigid with wedge means (116) arranged to cooperate with elements (121) movable in directions transverse to that of said movable member (106), to block the movement of the rear arms (12) at least when in their first working position.

11. A tricycle as claimed in claim 10, characterised in that the movable member is a lever (106) movable within a projecting part (100) in the connecting portion, said lever (106) being associated with a pushbutton (111) movable within a seat (112) in said part (100) and arranged to enable or to block the movement of the lever depending on its position within said seat (112), the lever being subjected to the elastic action of a spring contained in said projecting part (100) and being connected to the wedge means (116) by a rod (115) slidably inserted into a portion of said projecting part (100).

12. A tricycle as claimed in claim 11, characterised in that the wedge means are positioned at the free end of the rod (115) connected to the lever (106).

13. A tricycle as claimed in claim 11, characterised in that the wedge means comprise two opposing lugs (116) which are inclined to the rod (115) supporting them and which converge towards this latter.

14. A tricycle as claimed in claim 10, characterised in that the movable elements are at least two pins (121), each arranged to cooperate with a corresponding rear arm (12) of the tricycle, each pin (121) being subjected to the elastic action of a spring (122) which maintains it pressing against a disc (126) rigid with the end (11) of the corresponding arm (12).

15. A tricycle as claimed in claim 14, characterised in that each pin (121) is arranged to cooperate with a seat (125) provided in the disc, at least when the rear arm (12) is in its first working position.

16. A tricycle as claimed in claim 15, characterised in that the pin (121) also cooperates with a seat provided in the disc (126), when the rear arm (12) is in its second working position.

17. A tricycle as claimed in claim 14, characterised in that each pin (121) moves within a corresponding sleeve (124) discoidal to the connecting portion (17) under the action of the wedge means (116) and against the action of the respective spring (122).

18. A tricycle as claimed in claim 17, characterised in that the spring (122) is positioned about the sheath (124) of each pin (121) and acts with one end against a flanged end (120) of the pin (121), the other end of the spring being rigid with the sheath (124).

19. A tricycle as claimed in claim 11, characterised in that the projecting part (100) of the connecting portion (17) presents at least one aperture (104) for the operation of the lever (106), said part (100) being grippable through this aperture to transport the tricycle, said part hence acting as the gripping element for such transport.

20. A tricycle as claimed in claim 11, characterised in that the projecting part (100) is defined by a first part (98) rigid with the connecting portion (17) and a second part (99) removably secured to the first part (98) and acting as the protection cover for this latter.
